(19) United States
(12) Patent Application Publication
(10) Pub. No.: US 2014/0246140 A1
(43) Pub. Date: Sep. 4, 2014

(54) METHOD AND APPARATUS FOR PRODUCING AN EASILY APPLIED SELF ADHESIVE FLEXIBLE MAGNETIC SUBSTRATE

(71) Applicant: MALLETT MAGNETICS, LLC, Vincent, OH (US)

(72) Inventor: Shawn Mallett, Vincent, OH (US)

(73) Assignee: MALLETT MAGNETICS, LLC, Vincent, OH (US)

(21) Appl. No.: 13/784,754

(22) Filed: Mar. 4, 2013

(51) Int. Cl. B32B 38/10; B32B 38/04

(52) U.S. Cl. CPC B32B 38/10; B32B 38/04
USPC 156/152; 156/249; 156/536

(57) ABSTRACT

Disclosed herein is a method of preparing a magnetic substrate laminated with a PSA and release liner. The method comprises providing a magnetic substrate laminated with a PSA/release liner structure, removing a release liner from the PSA, and reapplying a release liner such that it is shifted in relation to the magnetic substrate to expose a portion of the PSA. A portion of the release liner may extend past an edge of the magnetic substrate, forming a tab to facilitate later removal of the release liner from the PSA. An attachment may be secured to the exposed PSA to create a customizable promotional item which may be further customized by the later removal of the release liner to allow a customized attachment to be affixed to a portion of the PSA.

### TECHNICAL FIELD

Exemplary embodiments of the present invention relate generally to a laminated customizable promotional product and methods of manufacture. More particularly, exemplary embodiments relate to a partially laminar structure having a magnetic substrate, a layer of pressure sensitive adhesive, and a release liner and methods of manufacturing the same.

### BACKGROUND AND SUMMARY OF THE INVENTION

In such an embodiment a magnetic substrate, with a permanent pressure sensitive adhesive applied to cover substantially one face of the substrate where a release liner is initially covering substantially the entire surface of the permanent pressure sensitive adhesive, is modified during a production process whereby the release liner is caused to be removed from the permanent pressure sensitive adhesive and a release liner applied to a first portion of the surface of the pressure sensitive adhesive opposite the surface in contact with the substrate such that the result is a second portion of the pressure sensitive adhesive being exposed along one edge of the substrate and a portion of the release liner overhanging the edge of the substrate opposite the edge whereupon the pressure sensitive adhesive is exposed.

In the field of customized promotional products it is a common practice to produce standardized promotional products that may be offered to individuals or organizations for later customization and personalization by adding identifying or other promotional material. The added items typically include business cards, photographs, illustrations, or other identifying materials. Often these additional items are added to a promotional product by removal of a section of release liner, exposing a pressure sensitive adhesive (“PSA”), and adhering the additional material to the exposed PSA. The result may be a promotional item that is economically produced in large quantities and customized by a purchaser in smaller quantities. A representative example of this type of item may be a small calendar affixed to a portion of flexible magnetic material. After purchase but before distribution as a promotional material, a release liner may be removed from the magnetic portion to expose a PSA and a business card applied to the exposed PSA. The resulting calendar may be affixed to a ferrous surface for display of both the calendar information and the attached business card.

Flexible magnetic materials may be formed by suspending magnetic particles in a flexible binder material such as nitrile rubber, polyethylene, or some other flexible material. Flexible magnetic substrate materials may be formed into shapes or a sheet structure by extrusion or calendaring. When formed in a sheet structure, the resulting flexible magnetic sheet material may be cut or shaped to a desired size.

PSAs may be applied to a substrate through a hot melt application or liquid/emulsion process and then covered by a release liner for protection so that the PSA can later be exposed for customization. PSAs used in these applications may also be a double coated PSA, a PSA transfer tape. When exposed to air or contaminants, a PSA may start to lose some of its adhesive properties. This process is commonly referred to as “detackification.” In order to prevent detackification or undesired adhesion to other materials, a release liner is commonly applied to a PSA.
A release liner material may be applied to the face of the PSA opposite of that face attached to a substrate to protect the PSA, prevent detackification, premature bonding, and allow the PSA to be exposed for customization at a later time. The release liner material may be made from paper, cloth, or other material coated with a release coat such that the material easily releases from the PSA. PSA materials are available with a release liner pre-attached to one face with the other face of the PSA exposed. Such a combination is commonly referred to as a transfer tape. The exposed PSA face of a transfer tape may be applied to a substrate while leaving the release liner in place until removal for later attachment. PSA materials are also available coated on both sides of a carrier material with release liners pre-attached to the faces of the PSA opposite the carrier material (the outside faces). Such PSA coated carrier materials having release liners pre-attached to the outside faces are commonly referred to as double coated. A double coated carrier is applied to a substrate by removing a release liner attached to one outside face, attaching the expose PSA face to the substrate, and leaving the remaining release liner in place until removal for later attachment. Such products are available from MACtac Specialty Products located in (Stow, Ohio), (MACfilm IF2092). A first face of the release liner is applied to a first face of the PSA and then the PSA/release liner combination is rolled onto a spool structure such that the second face of the release liner is placed in contact with the second face of the PSA. This results in a spool of PSA/release liner laminate structure that may be un-spooled such that the second face of the PSA is exposed for attachment to another material while the release liner remains attached to the first face of the PSA. Flexible magnetic materials may be supplied plain or coated/laminated with a permanent PSA, such as that manufactured by AMC Group, (Gao Xin Qu, Hefei.Anhui Province, China), (product code ZY-1). When a flexible magnetic substrate is laminated with a PSA and a release liner is applied to the exposed face of the PSA, a laminar structure results which may be affixed to other materials by removing the release liner and pressing the exposed PSA against the other material. When used to produce promotional materials, the other material may be a customizable display portion such as a calendar, list of phone numbers, a photograph, a sports schedule, or other display material as desired.

Past methods of applying or modifying release liner materials to flexible substrates such as the flexible magnetic substrates described above have required that the edge of the flexible magnet substrates, the PSA, and the release liner be aligned and not removed until final assembly to prevent detackification. The aligned release liner may have been formed from a single release liner or from a release liner which has been cut or scored as part of a separate manufacturing step to form more than one aligned release liners attached to a substrate. This alignment requires the release liner to be lifted with a fingernail or other thin object in order for the release liner to be gripped for removal. During attempts to lift the edge of the release liner, the release liner, PSA, or substrate were frequently damaged or contaminated such that the PSA did not properly adhere to items subsequently desired to be attached. Such methods are also time-consuming and potentially frustrating to the person removing the release liner material. Consequently, there is a need for laminar promotional product that has an easily removable release liner and method of manufacturing the same. Accordingly, exemplary embodiments of the present invention have been made to remedy the previous mentioned problems. The laminar promotional products according to the inventive concept present the user with a section of release liner not adhered to the PSA for easy removal of the release liner. Thus, by forming a substrate with an exposed area of PSA and a corresponding strip of release liner which overhangs the edge of the substrate, a manufacturer of promotional items may adhere promotional material to the exposed substrate in order to provide a promotional product which may be further customized by lifting the easily grasped overhanging release liner of the substrate without the need to use a fingernail or other thin object to lift the release liner.

The method and devices used to produce the inventive promotional product may have different embodiments. A first embodiment of the present invention is a device for and corresponding method of applying a PSA and release liner combination to a flexible magnetic substrate where the release liner is then removed from, offset, and then reapplied to the PSA. Another embodiment of the present invention is a device for and corresponding method of removal from, offset, and reapplication of a release liner to a previously assembled flexible magnetic substrate/PSA/release liner lamination. Another embodiment of the present invention is a device for and corresponding method of applying a PSA and release liner combination to a flexible magnetic substrate whereupon the release liner is removed and a different release liner is applied in a position that is offset from the first release liner. In still another embodiment of the present invention, include a device for and corresponding method of removal of the release liner from a previously assembled flexible magnetic substrate/PSA/release liner lamination and the application of a second release liner in a position that is offset from the first release liner.

### BRIEF DESCRIPTION OF THE DRAWINGS

The advantages and other characteristics of the disclosed embodiments will be better understood when attention is directed to the accompanying drawings, wherein identical elements are identified with identical reference numerals and wherein:

FIG. 1 is a perspective view of a magnetic substrate/PSA/release liner combination;

FIG. 2 is a perspective view of an exemplary embodiment of a magnetic substrate/PSA/release liner combination in which the release liner has been affixed in a manner to expose a portion of the adhesive in accordance with the inventive concept;

FIG. 3 is a perspective view of an exemplary embodiment of a magnetic substrate attached to an item of promotional material in accordance with the inventive concept;

FIG. 4 is a perspective view of an exemplary embodiment of a magnetic substrate which has a scored section of substrate;

FIG. 5 is a diagrammatic view of an exemplary process for applying a PSA/release liner combination to a magnetic substrate combined with removal, offset, and reapplication of a release liner material in accordance with the inventive concept;

FIG. 6 is a diagrammatic view of an exemplary process for applying a PSA/release liner combination to a magnetic substrate combined with removal, offset, and reapplication of the existing release liner in accordance with the inventive concept;

FIG. 7 is a diagrammatic view of an exemplary process for applying a PSA/release liner to a magnetic substrate, removal of the release liner, and the offset application of a separate release liner material to the magnetic substrate/PSA combination in accordance with the inventive concept.

FIG. 8 is a perspective view showing a possible embodiment of the release liner being removed and application of a separate release liner having an offset in accordance with the inventive concept.

### DETAILED DESCRIPTION OF EXEMPLARY EMBODIMENT(S)

Exemplary embodiments of the present invention are directed to a method of manufacturing a laminate material comprising a magnetic substrate, a PSA applied thereto, and a release liner applied to the PSA. The release liner is applied in such a way as to leave a portion of the PSA exposed while providing that a portion of the release liner extends beyond the magnetic substrate along an edge opposite the exposed adhesive.

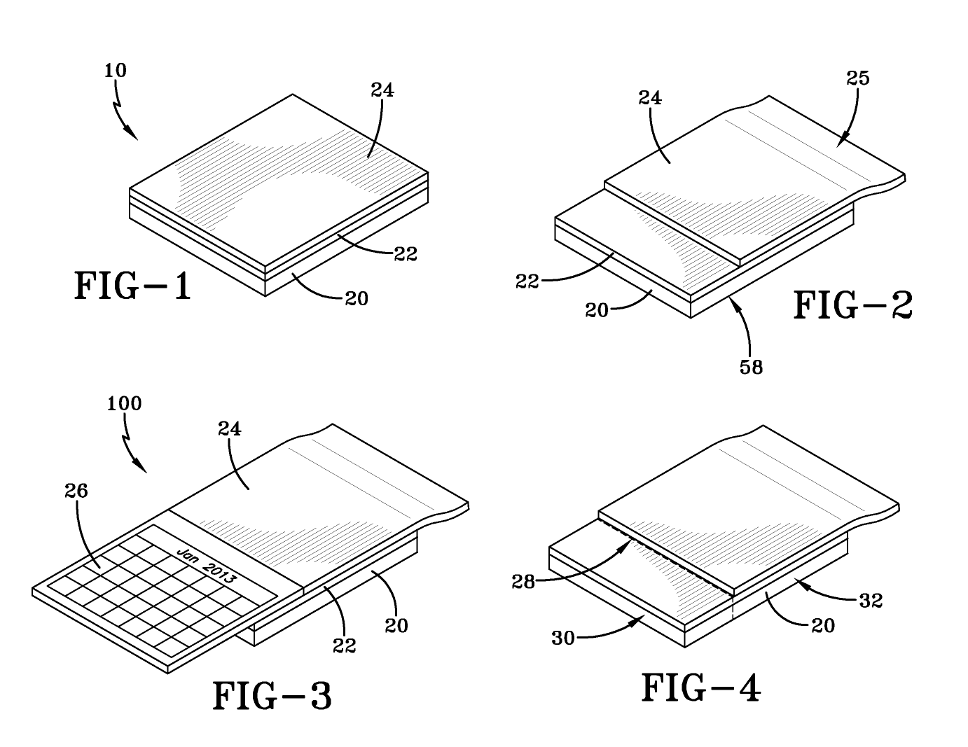

A traditional laminate material 10 used for promotional products is illustrated in FIG. 1. As shown, the traditional laminate material 10 includes a layer of PSA 22 interposed between a magnetic substrate 20 and a release liner 24. The release liner 24 covers the entirety of the PSA 22 to prevent detackification. As illustrated, the layer of the traditional laminate material 10 is arranged so that the edges of the magnetic substrate 20, the PSA layer 22, and the release liner 24 are aligned. Thus, in order to attach a promotional material, a portion of the release liner 24 may have been scored for removal to expose the underlying PSA layer 22.

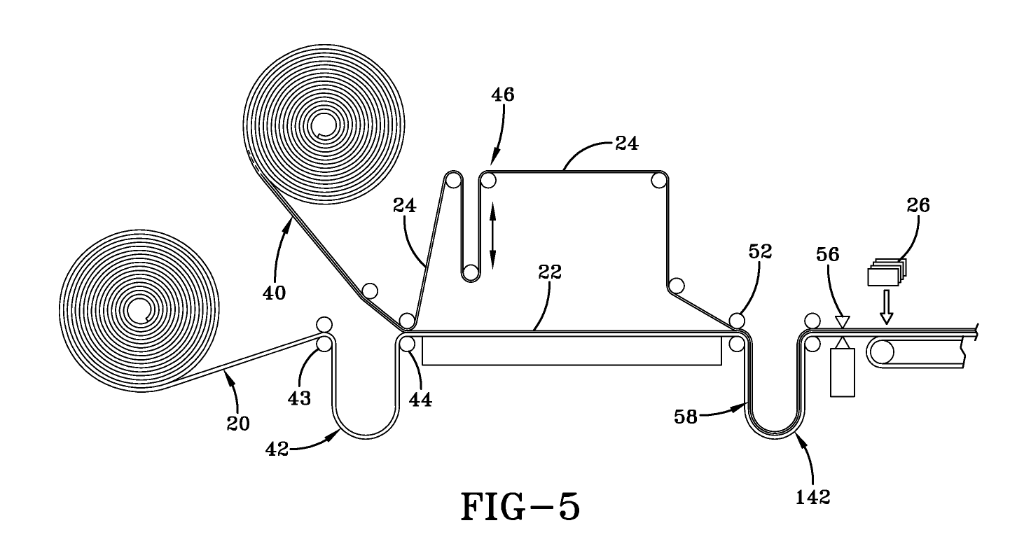

An exemplary embodiment of an assembly 58 according to the inventive concept is illustrated in FIG. 2. The assembly 58 includes a PSA layer 22, interposed between a magnetic substrate 20 and a release liner 24. The release liner 24 of the assembly 58 has the same area as the PSA layer 22 and the magnetic substrate 20; however, the release liner 24 is offset to expose a portion of the PSA layer 22 creating a tab 25. The tab 25 extends beyond the edges of the PSA layer 22 and the magnetic substrate 20 allowing easy removal of the release liner 24 from the PSA layer 22. The magnetic substrate 20 is typically a flexible magnet, but may be paper, plastic or other suitable material. The PSA layer 22 may be a double coated PSA, a one component PSA, transfer tape, hot melt PSA, a water soluble adhesive emulsion, or a solvent based adhesive. The release liner 24 may be comprised of paper, polyester, polypropylene, or any other liner material which is flexible and can be coated with a release coat material. FIG. 3 shows an exemplary assembly 58 having pre-printed media 26 affixed to the areas of the exposed PSA layer 22 forming a promotional item 100. The pre-printed media 26 may be a calendar as indicated in FIG. 3, or other appropriate material. The exposed surface of the release liner 24 may be imprinted with instructions, promotional material, or other illustrations, or may be left blank. In an instance of the promotional item 100, the release liner may be removed without the use of tools in order to affix an item such as a business card or other identification items. As illustrated in FIG. 4, a perforation and/or score line 28 may be formed in the magnetic substrate 20 in order to allow for an end-user to remove the pre-printed media 26, and a small portion of the substrate 30, leaving behind the remaining substrate 32 which may have been affixed to an item such as a business card as described above. It should be noted that the PSA layer 22 may be scored at the perforation and/or score line 28 of the substrate to allow easy separation.

Referring to FIG. 5, which illustrates an embodiment of a novel process for applying a PSA/release liner combination 40 to a magnetic substrate 20, removing and re-applying the release liner 24 such that the release liner may be offset to produce an assembly 58 as illustrated in FIG. 2. In this embodiment, a flexible magnetic substrate 20 is drawn from a supply of magnetic substrate 20. A PSA layer/release liner assembly 40 is also provided. The magnetic substrate 20 is drawn from the supply and passed through a set of rollers 43 into a tension loop 42. From the tension loop 42, the substrate is directed to nip rollers 44. The nip rollers 44 apply the PSA layer/release liner assembly 40 to the magnetic substrate 20. From the nip rollers 44, the release liner 24 is removed from the PSA layer 22 of the assembly 40 and directed to a Festoon accumulator 46. The festoon accumulator 46 acts to take the slack out of the release liner 24. After the festoon accumulator 46, the release liner 24 is then directed to a second set of nip rollers 52, where it is offset and applied to a first portion of the PSA layer 22 so that a tab 25, as shown in FIG. 2, is created that overhangs the magnetic substrate 20. This offset of the release liner 24 also exposes a second portion of the PSA layer 22. The assembly 58 then passes through another tension loop 142 and is directed to a cutter 56. The cutter 56 may cut the strip of assembly 58 into desired lengths. A pre-printed media 26 may then be applied to the exposed PSA layer 22 forming a promotional item 100.

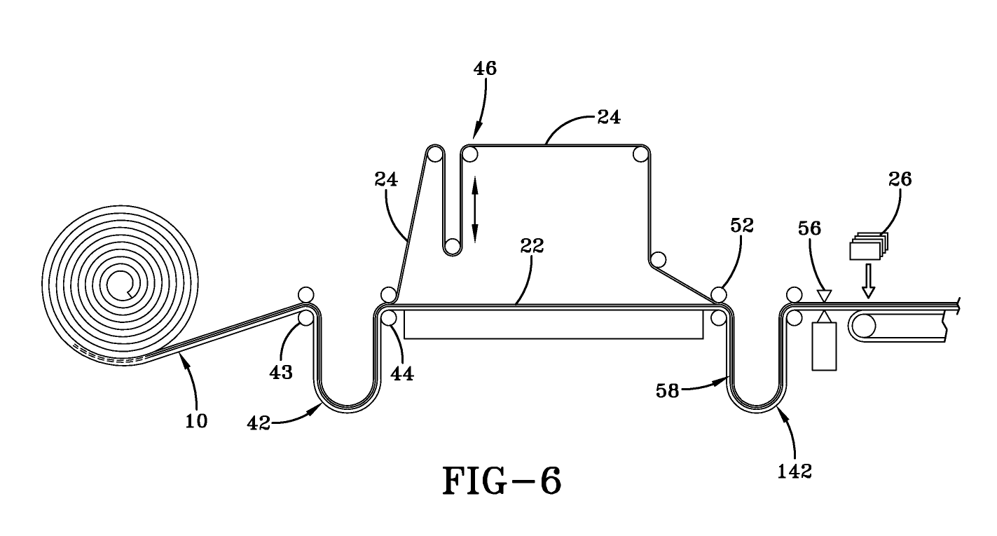

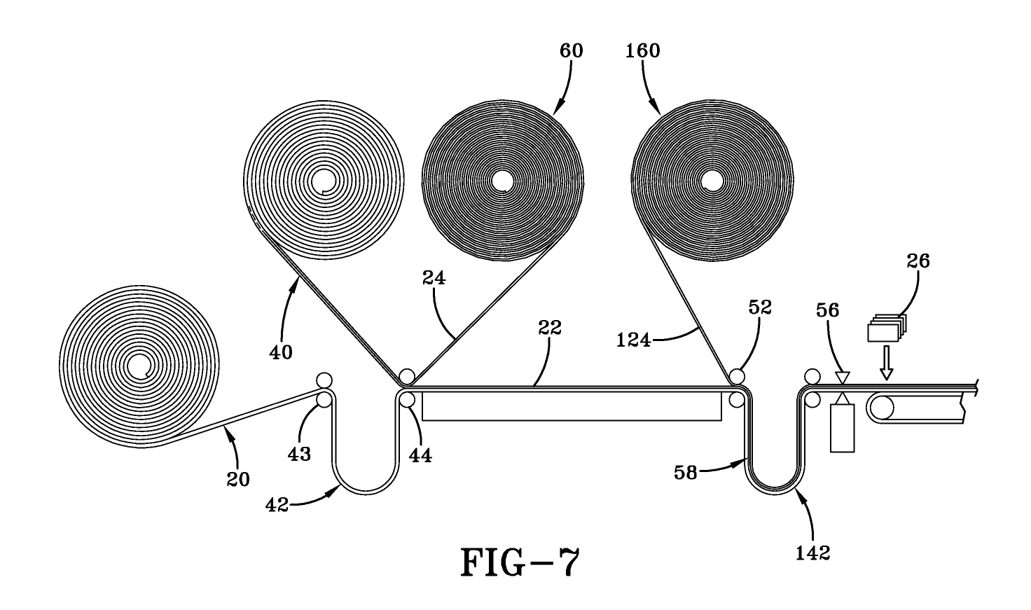

Flexible magnetic substrate may be purchase from suppliers with a PSA and release liner preassembled to the substrate (AMC Group Product ZY-1). Referring to FIG. 6 which illustrates an embodiment of a novel process for removing a release liner 24 from a preassembled magnetic substrate/PSA/release liner assembly 10 and re-applying the release liner 24 in a manner such that the release liner may be offset to produce an assembly 58 in FIG. 2. In this embodiment, a flexible magnetic substrate/PSA/release liner assembly 10 is drawn from a supply of assembly 10 and passed through a set of rollers 43 into a tension loop 42. From the tension loop 42, the assembly 10 is directed to nip rollers 44. The release liner 24 is removed from the PSA layer 22 of the assembly 10 and directed to a festoon accumulator 46. The festoon accumulator 46 acts to take the slack out of the release liner 24. After the festoon accumulator 46, the release liner 24 is then directed to a second set of nip rollers 52, where it is offset and applied to a first portion of the PSA layer 22 so that a tab 25, as shown in FIG. 2, is created that overhangs the magnetic substrate 20. The offset of the release liner 24 also exposes a second portion of the PSA layer 22. The assembly 58 then passes through another tension loop 142 and is directed to a cutter 56. The cutter 56 may cut the strip of assembly 58 into desired lengths. A pre-printed media 26 may then be applied to the exposed PSA layer 22 forming a promotional item 100.

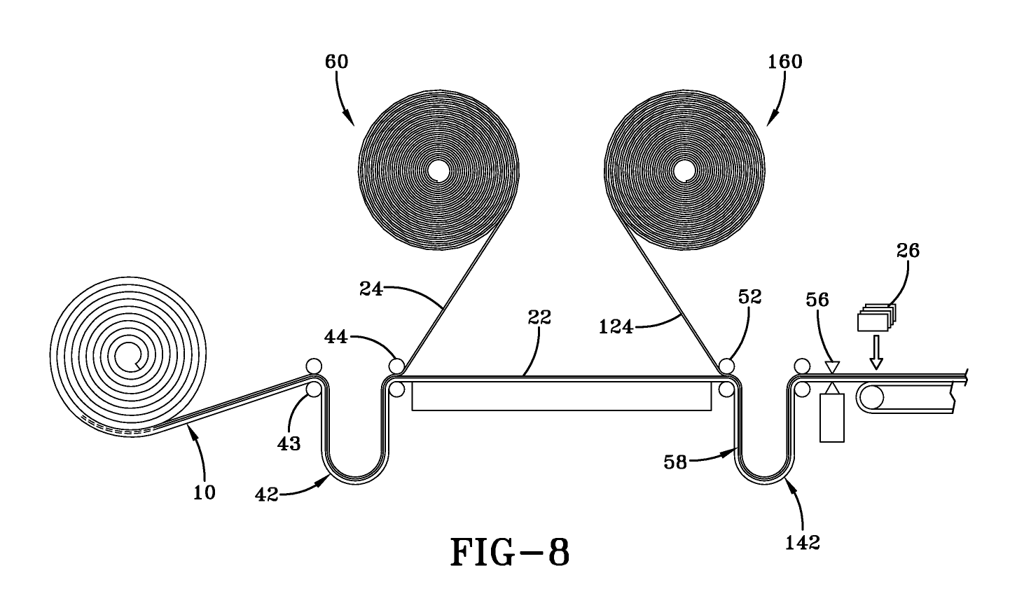

Referring to FIG. 7 which illustrates an embodiment of a novel process for applying a PSA/release liner combination 40 to a magnetic substrate 20, removing and re-applying the release liner 24 such that the release liner may be offset to produce an assembly 58 as shown in FIG. 2. In this embodiment, a magnetic substrate 20 is drawn from a supply of magnetic substrate 20. A PSA layer/release liner assembly 40 is also provided. The magnetic substrate 20 is drawn from the supply and passed through a set of rollers 43 into a tension loop 42. From the tension loop 42, the magnetic substrate 20 is directed to nip rollers 44. The nip rollers 44 apply the PSA layer/release liner assembly 40 to the magnetic substrate 20. From the nip rollers 44, the release liner 24 is removed from the PSA layer 22 and directed to a wind-up spool 60. The wind-up spool 60 acts to take the slack out of the release liner 24 and store the release liner 24 for possible later use. From a second spool 160, a release liner 124 is then directed to a second set of nip rollers 52, where it is offset and applied to a first portion of the PSA layer 22, so that a tab 25, as shown in FIG. 2, is created that overhangs the magnetic substrate 20. This offset of the release liner 124 also exposes a second portion of the PSA layer 22. The assembly 58 then passes through another tension loop 142 and is directed to a cutter 56. The cutter 56 may cut the strip of assembly 58 into desired lengths. A pre-printed media 26 may then be applied to the exposed PSA layer 22 forming a promotional item 100.

Referring to FIG. 8 which illustrates an embodiment of a novel process for removing a release liner 24 from a preassembled magnetic substrate/PSA/release liner assembly 10 and re-applying the release liner 24 in a manner such that the release liner may be offset to produce an assembly 58 as shown in FIG. 2. In this embodiment, a flexible magnetic substrate/PSA/release liner assembly 10 is drawn from a supply of assembly 10 and passed through a set of rollers 43 into a tension loop 42. From the tension loop 42, the assembly 10 is directed to nip rollers 44. The release liner 24 is removed from the assembly 10 and directed to a wind-up spool 60. The wind-up spool 60 acts to take the slack out of the release liner 24 and store the release liner for possible later use. From a second spool 160, a release liner 124 is then directed to a second set of nip rollers 52, where it is offset and applied to a first portion of the PSA layer 22 so that a tab 25, as shown in FIG. 2, is created that overhangs the magnetic substrate 20. This offset of the release liner 24 also exposes a second portion of the PSA layer 22. The assembly 58 then passes through another tension loop 142 and is directed to a cutter 56. The cutter 56 may cut the strip of assembly 58 into desired lengths. A pre-printed media 26 may then be applied to the exposed PSA layer 22 forming a promotional item 100.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A method of preparing a substrate laminated with a PSA/release liner structure, comprising the steps of:
providing a substrate laminated with a structure comprised of a PSA and at least one release liner;
removing at least one release liner from the structure;
shifting an edge of at least one release liner a predetermined distance away from an edge of the substrate; and
applying said shifted release liner to the PSA laminate of the substrate.

2. The method of claim 1, where the step of applying said shifted release liner further comprises the steps of:
causing said shifted release liner to contact a portion of the PSA laminate layer of the substrate; and
using a nip roller to apply pressure to the shifted release liner such that the shifted release liner removably bonds to the PSA.

3. (canceled)

4. The method of claim 1, further comprising the steps of:
accumulating said removed release liner on a first spool assembly; and
removing from a second spool assembly, said shifted release liner.

5. The method of claim 4, where the step of applying the shifted release liner further comprises the steps of:
causing the shifted release liner to contact a portion of the PSA laminate layer of the substrate; and
applying pressure to the shifted release liner such that the release liner becomes removably bonded to a portion of the PSA.

6. The method of claim 5, where said pressure is applied using a nip roller assembly.

7. The method of claim 1, further comprising the steps of:
accumulating said removed release liner using a festoon web accumulator;
removing said release liner from said festoon web accumulator; and
subjecting said removed release liner to said shifting.

8. The method of claim 7, where the step of applying the shifted release liner further comprises the steps of:
causing the shifted release liner to contact a portion of the PSA laminate layer of the substrate; and
applying pressure to the shifted release liner such that the release liner becomes removably bonded to a portion of the PSA.

9. The method of claim 8, where said pressure is applied using a nip roller assembly.

10. The method of claim 1, where the step of applying said shifted release liner to the PSA laminate of the substrate further comprises the sub steps of:
forming a score line through the PSA; and
forming a score line partially through the substrate.

11. The method of claim 1, where the step of applying said shifted release liner to the PSA laminate of the substrate further comprises the sub steps of:
forming a perforation through the PSA layer; and
forming a perforation through the substrate.

12. (canceled)

13. (canceled)

14. (canceled)

15. (canceled)

16. (canceled)

17. (canceled)

18. (canceled)

19. (canceled)

20. A method of preparing a substrate laminated with a PSA/release liner structure, comprising the steps of:
providing a substrate laminated with a structure comprised of a PSA and at least one release liner;
using a removal device to remove at least one release liner from the structure;
shifting an edge of at least one release liner a predetermined distance away from an edge of the substrate; and
using an application device to apply said shifted release liner to the PSA laminate of the substrate.

21. The method of claim 20, where the step of using an application device to apply said shifted release liner to the PSA laminate of the substrate comprises the following sub steps:
causing said shifted at least one release liner to contact a portion of said PSA; and
removably bonding said shifted release liner to the PSA laminate of the substrate using pressure applied by a first nip roller to the release liner and PSA such that an edge of the shifted release liner is located with a predetermined offset from an edge of the PSA.

22. The method of claim 21, where the step of using a removal device to remove at least one release liner comprises the following sub steps:
removing at least one release liner from the PSA using a second nip roller which compresses said PSA, said at least one release liner, and the substrate, prior to removal of said at least one release liner; and
receiving said removed at least one release liner on a device for receiving said release liner.

23. The method of claim 22, where the sub step of receiving at least one release liner is performed by a device comprising a first spool assembly and the step of shifting an edge of at least one release liner a predetermined distance away from an edge of the substrate is performed by a device comprised of a second spool assembly.

24. The method of claim 23, where the step of providing a substrate laminated with a PSA/release liner structure comprises the steps of bonding the PSA/release liner to a substrate using a nip roller.

25. The method of claim 23, with the additional step of cutting the assembly comprised of the flexible magnetic substrate on which the shifted release liner is removably bonded at a predetermined offset from an edge of the PSA, the PSA, and the release liner into pieces of predetermined length, each piece of predetermined length comprising a portion of flexible magnetic substrate, PSA, and release liner.

26. The method of claim 21, where the step of receiving at least one release liner is performed by a device comprising a festoon web accumulator and the step of shifting an edge of at least one release liner a predetermined distance away from an edge of the substrate is performed using a at least one release liner removed from the festoon web accumulator.

27. The method of claim 26, where the step of providing a substrate laminated with a PSA/release liner structure comprises the steps of bonding the PSA/release liner to a substrate using a nip roller.

28. The method of claim 26, with the additional step of cutting the assembly comprised of the flexible magnetic substrate on which the shifted release liner is removably bonded at a predetermined offset from an edge of the PSA, the PSA, and the release liner into pieces of predetermined length, each piece of predetermined length comprising a portion of flexible magnetic substrate, PSA, and release liner.

29. An assembly produced according to the method of step 20, comprising:
a substantially rectangular portion of flexible magnetic substrate comprising a first surface and a second surface;
a double-sided PSA material comprising a first and second adhesive side, with dimensions substantially the same as the flexible magnetic substrate, a first adhesive side of the PSA material affixed to substantially cover the first surface of the flexible magnetic substrate;
a release liner, with substantially the same dimensions as the flexible magnetic material, a first portion of which is removably affixed to a first portion of the second adhesive side of the PSA material, where the release liner is positioned such that a second portion of the release liner overhangs an edge of the substrate to form a tab which may be gripped in order to remove the release liner; and
a second portion of the second adhesive side of the PSA material, substantially the same dimensions as the tab formed from the release liner, remaining uncovered by the release liner along an edge opposite of the tab.
